(19) United States
(12) Patent Application Publication
(10) Pub. No.: US 2004/0121204 A1
(43) Pub. Date: Jun. 24, 2004

(54) Fluid electrical connected flow-through electrochemical cells, system and method

(76) Inventors: Marc D. Adelman, Worcester, MA (US); Michael J. Martino, Agawam, MA (US)

Correspondence Address: LESLIE MEYER-LEON, ESQ., IP LEGAL STRATEGIES GROUP P.C., 1480 FALMOUTH ROAD, P.O. BOX 1210, CENTERVILLE, MA, 02632-1210, US

(21) Appl. No.: 10/297,640

(22) PCT Filed: Jun. 7, 2001
(86) PCT No.: PCT/US01/18375

(51) Int. Cl. H01M 8/04

(52) U.S. Cl. 429/22; 429/13

(57) ABSTRACT

The invention relates to a flow-through electrochemical system having a plurality of flow-through electrochemical cells in electrical and fluid connection. Preferably, the flow-through electrochemical cells are flow-through capacitor cells. By monitoring and controlling the voltage of each individual cell, the system maximizes charge and voltage while minimizing amperage.

### REFERENCE TO PRIOR APPLICATION

This application is based on and claims priority from U.S. Provisional Patent Application Serial No. 60/210,035, filed Jun. 7, 2000, hereby incorporated by reference in its entirety.

### GOVERNMENT CONTRACT

This invention was funded under contract with the United States Defense, Advanced Research Projects Agency (DARPA), under Contract No. DAAD 19-99-C-0033. The United States government may have certain rights in the invention.

### BACKGROUND OF THE INVENTION

Flow-through electrochemical cells (FTC or FTCs) generally include flow-through capacitors, flow-through batteries, and flow-through fuel cells. FTCs are useful for energy storage, energy generation, and water purification. FTCs differ from ordinary electrochemical cells in that the tonically conductive solution between the electrodes, or the electrolyte, is introduced into the cell via one port, flows through or between the electrodes, and exits via another port or ports. The cell may be configured with a cartridge holder or container. FTCs are described in U.S. Pat. Nos. 5,192,432, issued Mar. 9, 1993; 5,196,115, issued Mar. 23, 1993; 5,200,068, issued Apr. 6, 1993; 5,360,540, issued Nov. 1, 1994; 5,415,768, issued May 16, 1995; 5,425,858, issued Jun. 20, 1995; 5,538,611, issued Jul. 23, 1996; 5,547,581, issued Aug. 20, 1996; 5,620,597, issued Apr. 15, 1997; 5,748,437, issued May 5, 1998; 5,779,891, issued Jul. 14, 1998; and 5,954,937, issued Sep. 21, 1999, each hereby incorporated by reference.

An FTC suffers the limitation that each FTC cell requires a high operating current or amperage. The amperage required to operate the cell increases with cell size, flow rate, and concentration of ions in solution. High amperage power is cumbersome and expensive to supply, requiring heavy duty relays and wires. Operating an FTC at too low a voltage leads to poor performance, so that, for example, when used for water purification, the water is not purified sufficiently. Operating an FTC at too high a voltage may lead to cell burnout, hazardous gas generation, or oxidation and deterioration of electrodes. For example, under some conditions, it is desirable to limit the maximum voltage of an individual cell in a carbon electrode FTC to 1 volt or less. This creates a need to monitor and control each cell in a series stack individually. Therefore, a need exists for a means of monitoring and controlling voltage in individual cells, so as to be able to operate the flow-through capacitor with ordinary, higher voltage power, while being able to control the voltage of each individual cell.

### SUMMARY OF THE INVENTION

The invention comprises an FTC system and method, which include a plurality of FTCs in electrical and fluid connection.

A controlled FTC system and method which include a plurality of FTCs connected in an electrical series arrangement with fluid flow-through, and having an electrical control circuit to monitor and control the voltage on each individual FTC in the series.

The invention comprises a flow-through electrochemical system which includes a plurality of flow-through electrochemical cells, the system configured to place each of the cells in electrical connection and in fluid connection with each of the other cells. The invention also includes a fluid stream, a means for connecting the system of the invention to a power supply, a means for monitoring the voltage of each of a plurality of cells and a means for controlling the voltage of each of the plurality of cells.

A means for controlling the system of the invention can include a valve, for example, a bypass valve, the bypass valve can be actuated in a feedback loop to control the voltage of each of the cells of the invention. The valve of the invention can be an incremental valve, a differential valve, or a linearly-actuated valve. The controlling means of the invention can also include a transistor or a zener diode.

In one embodiment, the flow-through electrochemical system of the invention includes a flow-through capacitor and a plurality of cells that form a series stack. The charge of the series stack can be proportional to the sum of the capacitance of each of the cells multiplied by the voltage of each of the cells.

The means for monitoring the voltage of the cells of the invention emits a signal, the signal is compared to a reference signal so as to activate the controlling means when the comparison is outside a preset range, whereby the controlling means decreases the extent of fluid connection between one or more of the cells and the remaining cells of said plurality of cells in the system.

The monitoring means of the invention can include a differential amplifier, which amplifier's signal is inverted. The monitoring means of the invention can further include an error amplifier which emits a signal.

The electrical connection between cells may be a series connection or a parallel connection. The fluid connection between cells may be a series connection or a parallel connection. Preferably, the electrical connection of the invention is a series connection, and the fluid connection of the invention is a parallel connection.

In one embodiment, the system of the invention can be an electrical generator. The system of the invention further can also be an electrical storage system or a water purification system. Fluids useful in the invention can be water, water-soluble ionic solutions, or fuels, for example, gasoline, methane, or hydrocarbons. Additional fluids useful as fuels are known to those skilled in the art.

The method of the invention can include a method of removing a chemical species from water, the method including the steps of providing the flow-through electrochemical system of the invention, the fluid stream being a water stream. The chemical species may be absorbed by one or more of the cells so as to remove the chemical species from the water stream.

Another method of the invention can include a method of generating electricity by the system of the invention, in which case and the fluid stream of the system is a fuel stream. The method of the invention includes operating the system of the invention, the fluid stream of the invention being a fuel stream.

### BRIEF DESCRIPTION OF THE DRAWINGS

FIG. 1 shows an FTC system with a plurality of FTCs in series and with an error control circuit;

FIG. 2 shows, in greater detail, a section of the circuit of FIG. 1;

FIGS. 3A and 3B show further separate, optional embodiments of the error control circuits;

FIG. 4 shows further separate, optional embodiments of the error control circuits;

FIG. 5 shows further separate, optional embodiments of the error control circuits; and

FIG. 6 shows an FTC with separate electrically isolated monitory leads.

### DETAILED DESCRIPTION

To achieve a system of FTCs, the flow-through capacitor with ordinary, higher voltage power, while being able to control the voltage of each individual cell, multiple FTCs are connected in series. The voltage of the series stack will be additive, proportional to the multiple of the individual cell voltages, and the amperage will be proportionately reduced, thereby obtaining a system which utilizes the same amount of power, but with higher volts and less amps. In one embodiment combined in electrical connection in series, the cells are interconnected by manifold valve means, so that fluid flow goes through each cell.

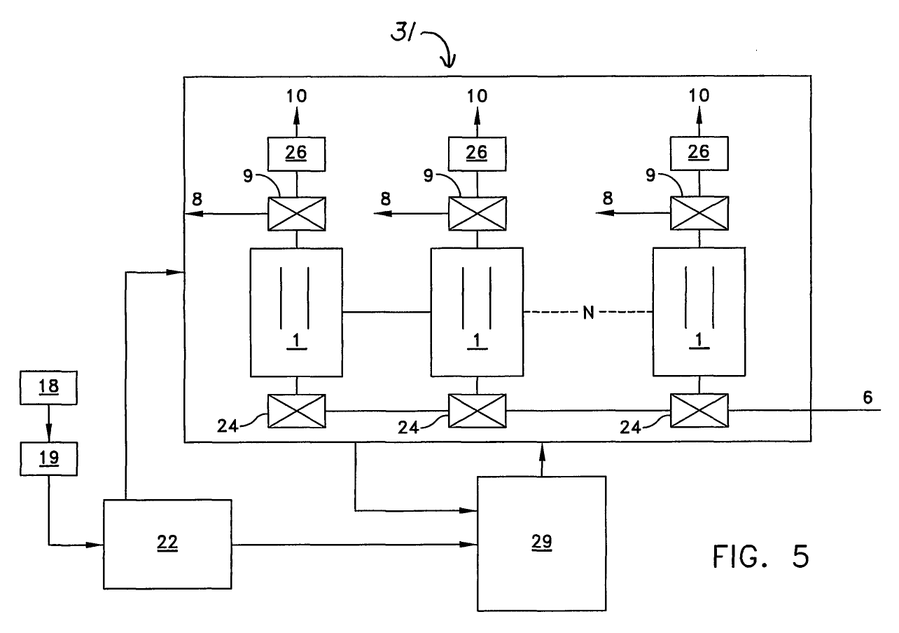

A preferable option is series electrical connection and parallel fluid connection. The parallel fluid flow may be achieved by a manifold valve or a series of linearly-actuated valves with feedback control from flow or pressure controllers in order to maintain equal flow through each cell. For example, flow-through capacitors are connected electrically in series, and fluid flow is connected in parallel, by a manifold valve, or with interspersed bypass valves, such as in FIG. 5. Fluid flow in parallel to an electrical series connected flow-though electrochemical cell stack is particularly advantageous as a means to maintain steady voltage among individual cells. This is especially important where flow-through capacitors are employed, since these cells change voltage per unit time. Parallel fluid flow-through electrically connected in series flow-through capacitors helps to maintain similar voltages among each of the cells. This flow may be equally distributed by control valves or adjusted individually for each cell as a means to maintain voltage or product water quality according to this invention. Alternatively, electrical connection in series, combined with fluid flow in series, would be useful in certain instances where adding flow-through capacitor cells in fluid series was of interest, to increase percentage purification or to add additional purification stages. Downstream capacitors, in this case, could be sized to be larger than the upstream ones, as an aid to achieve similar capacitance of each cell in the electrical series stack. For simplicity and for the purposes of this invention, it is understood that a series cell is any combination of parallel FTCs that are connected in series, either electrically or in a fluid sense. For example, one or more individual FTCs may be electrically connected in parallel. These combined parallel FTCs may in turn be connected in series. Therefore, any combination of electrical and fluid series and parallel connection is possible. The amperage draw is directly proportional to the size of the electrical series connected cells. This size may be varied, dynamically if desired, in order to adjust to changing power availability. For example, if high amperage but lower voltage power is available, it may be desirable to parallel connect individual FTC's in order to provide larger series connectable units. For example, two or more FTC cells at a time may be hooked electrically in parallel, and these combined units of two cells or more may in turn by hooked electrically in series. An interesting option would have flow initially parallel through the individual cells, but switch during the charge cycle to series flow through the entire stack, or through the bundled parallel connected cells that form the series units within the series stack, in order to maintain product purity for a longer amount of time in a given charge cycle.

When connecting FTCs electrically in series, a problem arises in that the cells do not necessarily self adjust to the desired voltage. Parallel flow is useful to maintain similar voltages between individual cells of the series stack. In addition to parallel flow, individual FTC monitoring and control are a preferred embodiment of this invention. Individual cells may deviate from each other, in spite of parallel fluid flow, due to a number of factors, including the difficult to manufacture uniform cells that maintain the same capacitance or charge characteristics during the life of the cell. It is desirable to control both the individual cell voltages in order to prevent overcharging individual cells. Should a cell fail entirely, it is desirable to cut off the flow so as to maintain product water quality. Should a cell fall within a desired range, it is desirable to regulate the individual cell voltage. This may be done by either electronically or by utilizing fluid flow as a means to regulate voltage. If done electronically, it is necessary to combine this with a means to shut off the flow cell from fluid flow so as to protect the product water quality. It is further desirable to control these voltages in such as way as to be able to set a limit on the maximum voltage an individual cell may reach.

There is a large amount of literature on how to control electronically series electrochemical cells of the non-flow type. All of these means can be applied to control electronically FTCs, when combined with the flow control means of this patent, including without limitation: U.S. Pat. Nos. 4,238,721; 4,719,401; 5,764,027; 5,773,957; 5,821,733; 5,886,503; 5,969,505; 5,982,143, each hereby incorporated by reference. These methods utilize electronic means such as diodes and resistors, to regulate the-voltage to each individual electrochemical cell in the series stack. FTCs connected electrically in series provide the additional option of being able to utilize valves to regulate the individual cell flow and/or voltages, or as a shut-off to stop the flow of electrolyte from a failed flow-through capacitor cell, in order to protect the product water quality, or to prevent additional fuel or fluid from entering a failed fuel cell or failed vanadium redox battery in an electrical series stack of such cells. Generally, voltages, amperages, and rates of change of volts and amps may be measured for individual cells and input into a logic means, such as an alogorithm, that is used to regulate the individual cell voltages according to the present invention. This logic means may be a computer program or electrical circuit that utilizes, for example, control schemes, theories, or circuits as published and known to those skilled in the art (see, e.g., Process Control Instrumentation Technology, Fourth Edition, by Curtis Johnson, Published by Prentice Hall Career & Technology, Englewood Cliffs, N.J. 07632, 1993).

In the particular case of the flow-through capacitor type of flow-through electrochemical cells, there is a fundamental difference in how series flow-through capacitors of the invention are used to store charge, compared to series capacitors of the electrical energy storage type. Capacitors of the energy storage type obey the following law when in series:

$$1 / {C}_{s} = {\sum }_{i = 1}^{i = n} 1 / {C}_{i} and {Q}_{s} = {C}_{s} {V}_{s} \qquad ( 1 )$$

where Q is charge, C is capacitance, V is voltage, and number of cells i may vary from 1 to typically not more than 1000.

This greatly limits the amount of charge stored, because charge storage is dependent upon the series capacitance, which is the sum of the inverses of the individual capacitances.

Equally-sized flow-through capacitors in series obey the following law and are not limited by the smaller series; capacitance in the amount of charge stored-charge storage is governed by the sum of the individual capacitances.

$${{Q}_{s}}_{i = 1}^{i = n} = α \sum {C}_{i} {V}_{i} \qquad ( 2 )$$

where s is a series, i is an integer greater than or equal to 1, and a is a proportionality constant that may be greater than unity. The series flow-through capacitor of the invention utilizes the internal ionic-charge storage ability of each individual cell in the series stack, in order to purify fluid-containing ionic contaminants and utilizes this in each of the individual cells in the stack. The sum of this charge, according to equation (2), is proportional to the amount of ionic contaminants removed from the purified stream.

Flow control may be used as a means to regulate individual cell voltages, in combination with electrical series connection with flow-through cells. This method may be used alone, in combination with electronic individual cell monitoring and voltage control, or in combination with limit controls that bypass failed capacitors and shut off flow-through individual failed cells by a valve and valve controller. For example, if one cell in the series short-circuits, fails catastrophically, or deviates from acceptable performance, it is desirable to turn off or bypass the flow via a valve.

In addition to turning off the flow, it is often also desirable to shunt or bypass electronically the cell from the electrical series stack. In some cases, an individual cell may deviate from optimum levels, but may still have some useful function. In this case, an adjustably-actuated or linearly-actuated valve may be used to increase or decrease the flow rate. By adjusting the flow rate, the individual cell voltage may be affected. It is further desirable to monitor the voltage of each individual cell and use, to control the valves 24 to shut off flow to an individual cell entirely, should the cell short-circuit, or fail beyond a preselected range, for example, with a voltage that deviates greater than, e.g., 20% from than other cells. This may be accomplished by a feed back, a computer controller, or by hard wiring, with the aim of regulating the individual cell voltage.

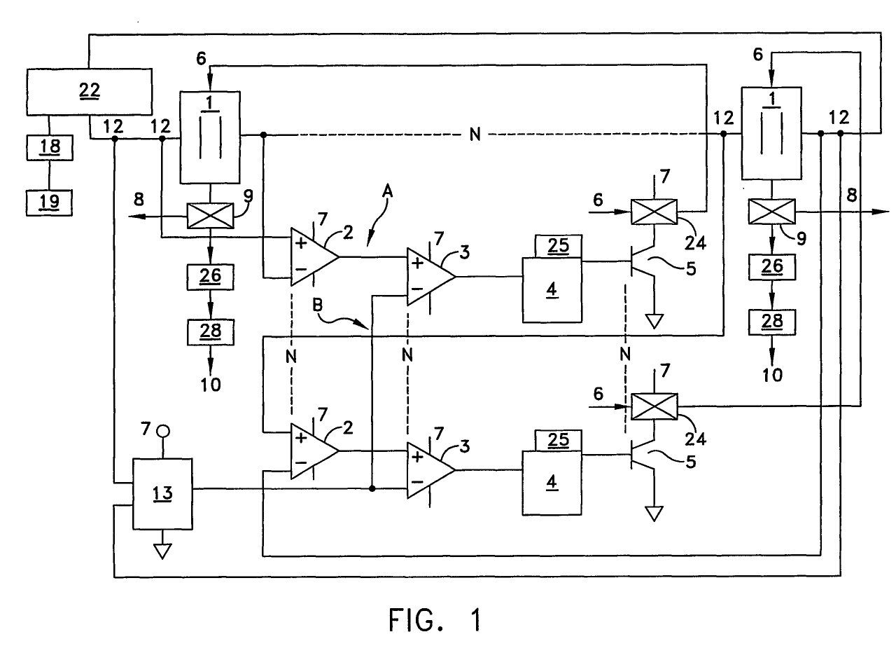

The controller used to operate the linearly-actuated valve may be a conductivity controller that monitors product water quality, a flow controller that monitors flow rate, or, preferentially, a voltage controller that monitors voltage on individual flow-through electrochemical cells. Alternatively, individual cell voltages may be regulated automatically by electronic means, such as with a field effect transistor (FET), transistor, or zener diode. However, if voltage is regulated by electronic means, shut-off or adjustable valves described above will be required in the event that the individual cell fails and needs to be shunted out of service or should the flow need to be adjusted or fine tuned in order to protect the product water quality. In FIG. 1, optionally, a conductivity controller 26 may be used to measure water quality, in order to operate the valves 9 or 24 to individual cells, in conjunction with the automatic electronic cell voltage control. Optionally, a limit switch 25 may operate valves 24 or 9, in order to turn the flow through the cell on or off completely, once an allowable, preset limit is reached, for example, 20% or greater deviation as read through the differential amplifier 2. The common theme is that the flow-through cells are monitored and controlled individually, combined with the ability to control the fluid flow.

It would further be desired that each electrochemical cell operate within a specified voltage range, for example, plus or minus 30% or less of each other.

Voltage divides across a capacitor in series, such that the highest voltage goes across the smallest value capacitor. A bad cell, such as a cell showing an abnormally low capacitance, can therefore exceed the voltage for electrolysis. This can cause failure of the cell, along with formation of harmful gasses, excessive current draw, etc. Therefore, a need exists to monitor and control individually the voltage of each cell in a series stack of flow-through cells. When a flow-through electrochemical cell fails, such as by showing too low or too high a voltage, flow of electrolyte into the cell needs to be adjusted or turned off completely as a means to control voltage and improve control of product solution quality. For example, a bad cell in a series of FTCs would contaminate the product stream with water that is incompletely purified compared to the other series cells. This bad cell needs to be either shut off from service completely, by way of a shut-off valve, or flow adjusted by way of an incrementally or linearly-actuated valve, in order to adjust the quality of the product water. Each cell is monitored individually for voltage. That voltage is compared to the other cells in the stack. An average or a mean, difference, or other mathematical formula may be used, programmed into a computer, or hard wired in order to determine if that particular cell is off specification. One way to do this is to read the voltage at either end of the stack, and divide by the number of cells in the stack. A more accurate way to monitor individual cell performance is to average the monitored voltage of each individual cell all together and compare that to each single cell, in order to determine which ones deviate too far from the average or mean. Hard-wired electrical circuitry may be used to accomplish this, or computers, microprocessor controllers, or program logic controls may be used. Using computers, a standard deviation may be selected, or at least squares analysis may be done, in order to analyze and compare each cell. Subsequently, this information may be input into computer controls that individually control each cell in the series stack.

In order to enhance the ability to monitor individual capacitor cells, it is highly desirable to incorporate separate sensing leads into the cell. For example, in a flow-through capacitor, separate sensing leads may be formed by incorporating additional metal to graphite connections for each bundle of anode or cathode leads. These sending leads are additional to and separated from the metal to graphite connections that deliver electric current to the capacitor. They may be separated along the same piece of graphite foil. Another embodiment is to have a separate piece of sensing lead graphite foil that forms a separate contact to the operating capacitance-containing electrode. For example a flow-through capacitor cell utilizing graphite foil current collectors and carbon cloth can have a sensing graphite foil one side of a piece of activated carbon cloth and a separate power supply graphite foil current collector on the opposite side of the same piece of activated carbon cloth. In this way, the sensing lead is isolated electrically from the graphite foil current collectors and measures the voltage on the carbon cloth more accurately.

Series stacks or individual flow-through capacitors may be operated at either constant current or constant voltage. Constant current charge requires less energy from the power supply. The reason is that less energy is lost between the power supply and the capacitor when charging at constant current. By selecting a constant charging current to, e.g., 80% or less than the maximum possible constant voltage charging current, as measured at, e.g., 1 volt, resistive losses may be further minimized. Supplying a constant current charge from the power supply, followed by supplying a constant voltage charge from the power supply, has a further advantage in lowering energy usage and extending purification cycle time. A preferred embodiment of the present invention is therefore the combination of series flow-through electrochemical cells of FTCs with constant current charge supplied from the power supply. Another variation of this embodiment is to supply an initial constant current charge from the power supply to either a single or a series stack of FTCs, followed by a constant voltage charge from the power supply to the FTCs. This has the advantage of extending the run or cycle time. Optionally, one may also initially charge the FTCs at constant voltage, then move to constant current, and optionally, return back to constant voltage.

In one embodiment, a stack of any number N of flow-through capacitors are connected in series as shown in FIG. 1. In this example, N=10 FTCs. These cells are shown as 1 in FIG. 1. For the purposes of this invention, each series cell 1 may be a combination of cells connected electrically in parallel. Each flow-through capacitor is a similar number of farads in the range of 1 farad to one million farads, e.g., 10,000 farads, for example from one million to one billion farads, within 10% more or less, in size, as measured when filled with an electrolyte of 0.01 M NaCl. It is desired to charge each cell to a maximum of 0.5 to 2 volts, e.g., 1 volt or 1.2 or 1.3 volts. It is further desired that, during the charge cycle, each cell be maintained within, e.g., 20% of the voltage of each of the other cells. Where individual series FTCs deviate from each other in capacitance by greater than, e.g., 1%, it becomes desirable to regulate the voltage by the present invention.

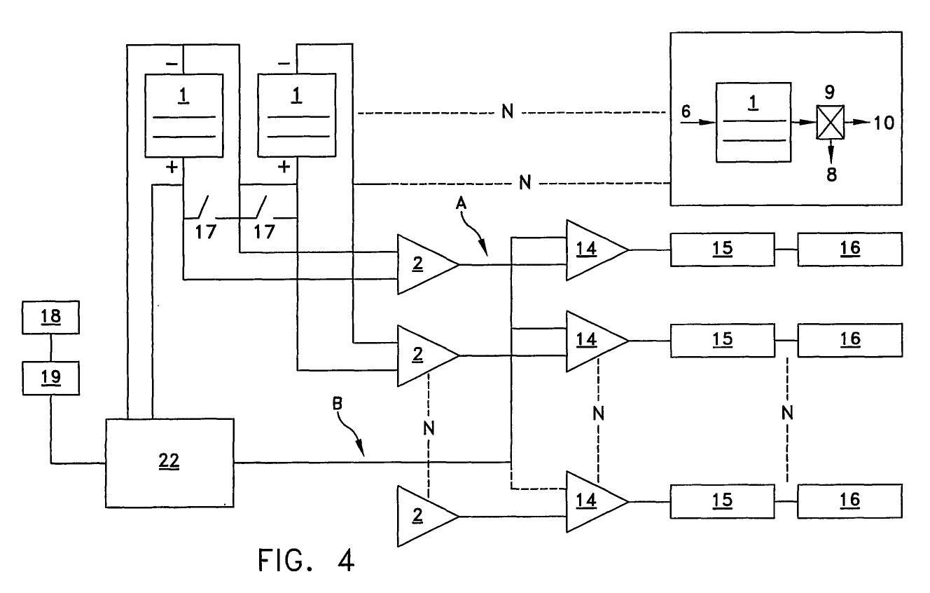

A counter 18 may be preset with the number of individual cells or may count the number of cells that are in service and not being bypassed by a shorting relay, such as 17 in FIG. 4. This counter 18 operates a logic or controller 19, which operates a source of DC power supply 22. Preferably, however, cells are counted automatically by a counter 18, such as a digital or electronic counter 18 that counts the number of cells in service. This is provided to logic or controller 19 that operates the power supply 22 accordingly, in order to supply a voltage to either end of the FTC stack, according to a proportional or integral multiple of volts times the number of cells counted. The proportionality constant may be set in RAM, ROM, by rotary switches, or vary according to computer logic. The voltage selected per cell may follow any sort of logic and, typically, may vary with time, or, optionally, may be constant or constant in voltage steps that alter with time. This voltage may be shunted to zero in order to discharge the capacitor. Preferably, polarity may be reversed occasionally or during alternate charge cycles. Polarity reversal may be performed by the differential amplifier 2 and at other necessary points in the circuit, as required.

FIG. 1 shows a series array of a flow-through electrochemical cell 1, which may be or a flow-through capacitor, fuel cell, vanadium re-dox battery, or flow-through battery. There are a number n cells in the array, where n may be any number greater than 2, for example, n may be 29, or n may be 600.

A differential amplifier 2 reads the voltage throughout the charging period of an individual FTC. It reads a voltage of 0.8 volts across one of the cells in the series stack at a time, five minutes into the charging period and inverts that voltage. The divide by N circuit 13 can also be manually preset with the desired voltage or can automatically determine the voltage that is desired, at each time point t. For example, the divide by N circuit can determine the voltage of the stack, either by measuring the voltage at any time t at either end or by adding the individual cell voltages. The desired individual cell voltage may be determined by dividing this stack voltage by the number of cells. Alternatively, a controller 19 may be used to compute mathematical means. The controller 19 may be a computer or other logic means. A standard deviation or least squares analysis may be done to determine if a particular cell is within acceptable parameters, which parameters may be selected by the operator. Alternatively, a simple percentage, in this case, plus or minus 10%, is input by the operator. A counter 18 may be used to count how many cells are in the stack at a particular time. If a cell is shunted or shorted out of service, this counter 18 resets to N-1, N-2, etc. This desired individual cell voltage is added to the inverted signal obtained through the differential amplifier 2, in order to obtain the error voltage and feed this into the or summing amplifier 3, which acts as an error amplifier.

It is important to determine and count the presence of individual, flow-through electrochemical cells connected in series, in order to monitor and control them according to the present invention or to know which cells are not functioning properly so as to bypass electricity or fluid automatically into an individual cell of the series stack. Several methods exist to determine the presence or threshold functionality of a cell in a series stack of flow-through electrochemical cells or flow-through capacitors. A preferred method is to provide a small constant current to each cell, for example, between 5 milliamps and 1 amp. This constant current will start to charge the cell and cause a change in voltage. The voltage is monitored, for example, by a microprocessor, analog to digital converter, volt meter, measuring the voltage drop across a resistor, or by a hall effect transformer. This voltage or the change in voltage per unit time will be fed into a logic means to verify the existence of the cell. For example, a dV/dt of between 1 mV/second and 1 volt per second would be used as a threshold in a logic means to affirm that the cell functions properly or exists. An example of a logic means includes microprocessors programmed with these threshold values. Once a threshold value is measured and input into the microprocessor, this in turn increments a counter means. The counter means may be microprocessor or computer program. Once the proper functioning or existence of the cell is determined, the counter means will, for example, increment by one. This procedure will be used to count how many cells exist in the series stack. Where the flow-through electrochemical cell is a flow-through capacitor, a water conductivity controller measurement may also be used to provide a threshold value to a logic or controller means that a cell exists. For example, a deviation of more than 10% in purification from other cells, or the conductivity or other measurement that indicates less than 50% total dissolved solids removal, or an increase in concentration of the purified water of more than 5% from the lowest measured value during a particular charge cycle may be used to control individual or series-connected flow-through capacitors.

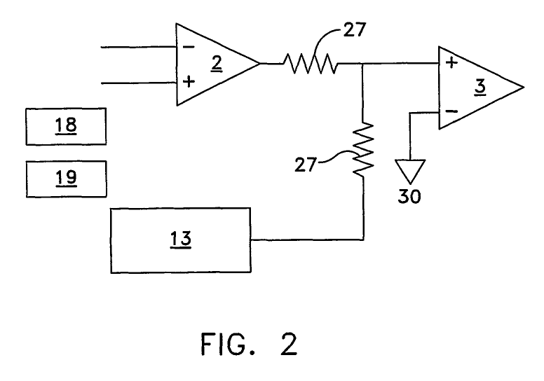

FIG. 2 shows a close up of the circuit of FIG. 1 with resistance 27 included. FIG. 2 is only one method. Any circuit that will provide the difference, at any time t, between a desired individual flow-through capacitor voltage and the actual flow-through capacitor voltage, and which will also enable controlled amplification of that error voltage, will suffice. This error, after conditioning in conditioning circuit 4, is then used to feed a transistor 5 or equivalent, for example, in its linear region, in order to control an incremental or linear actuator-operated valve 24. Voltage and power 7, where shown, is supplied to valves, amplifiers, etc. The system is grounded by ground 30. The circuit must be powered up first to operate. The valve 24 will control the flow fluid 6, which in turn affects and controls cell charge, and therefore, the voltage of cell 1. This voltage is read by differential amplifier 2, is combined with the signal from the divide by N circuit 13, amplified by the summing amplifier 3, conditioned in conditioning circuit 4, and ultimately used to control the same valve 24, thereby providing a feedback loop. This feedback loop provides a voltage-regulated FTC series stack that is controlled by regulation of fluid flow to the individual cells. If, for example, the cell is under charging, such as the example above where 1 volt was desired, but only 0.8 volts was read by differential amplifier 2 from the individual cell, the error signal from summing amplifier 3 would increase. This error signal will increase the flow rate by opening either valve 24 or valve 9. Increased flow rate provides more solution ions to the capacitor and allows the capacitor to charge up faster, hence increasing the voltage at a faster rate than the other series cells. This allows the cell voltage to catch up to the other cells. The differential amplifier 2 determines the cell voltage at any time t and automatically throttles up the valve. If the cell is overcharged, the opposite is true. A delay timer or a set point switch may optionally be added to the circuit, or added into the error amplifier, so that the linear actuator throttles up either valve 9, or valve 24, or both, if the cell is under a desired voltage, or down if the cell over a desired voltage, and only for desired period or time or when a desired set point is reached. This set point signal may be fed back from the voltage reading on the capacitor, such as through differential amplifier 2. This signal may be set to within any desired percentage of the final target voltage. Three-way valve 9 controls water product stream 10 and shunt product to waste stream 8. Valve 9 may also function as a back-up on/off valve, with a relay and additional control or logic means that turns valve 9 and/or 24 to off, if the error voltage from a differential amplifier 2 or conditioning circuit 4 is set above or below preset limits.

Optionally, conductivity sensor 28 may be used to provide a feed back signal to the differential amplifier 2. This provides the option to control individual cells based upon product water output quality. This particular example utilizes proportional control. Integral and differential control may be added also, as desired, with the use of computer controls and software. This is known as proportional integral differential(PID) control. The series stack may be provided with either a source of constant voltage or constant current power, or a variable source of power which varies the current, the voltage, or both with time.

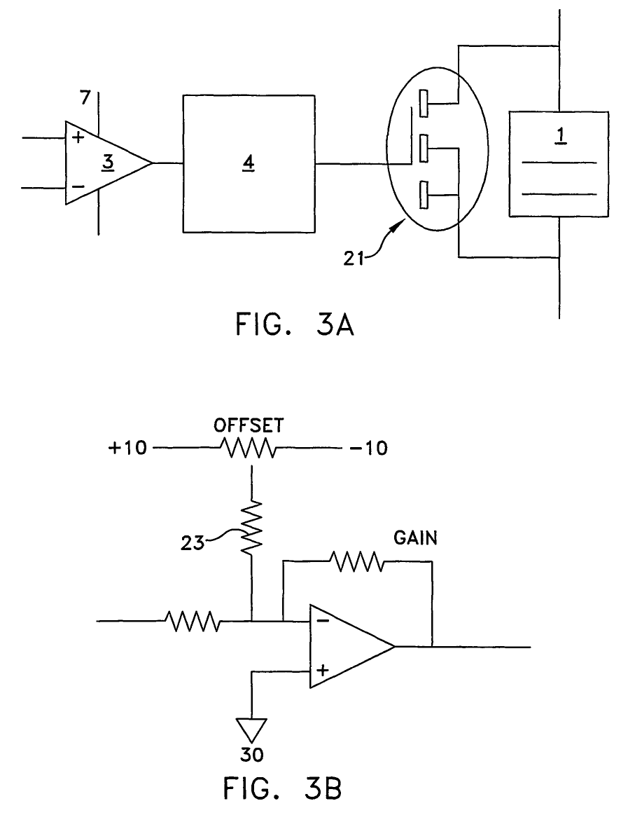

Alternatively FIG. 3A shows the conditioning circuit 4 can control a FET, transistor, or similar device as shown as transistor 21 in FIG. 3A. The FET or other such device, controls and regulates the voltage across each individual cell 1, in place of or in addition to the incrementally or linearly-actuated valve 24 and transistor 5 of FIG. 1. The close up, in FIG. 2, shows optional resistor 23.

It is desirable to protect water quality in the event of the failure of a single cell. FIG. 3B shows a circuit that monitors individually each cell in the series stack and which bypasses the individual cells when a preselected failure is reached, for example, when product water purification from an individual cell is less than 70% of the feed, or when it goes above a set conductivity point, for example, 100 microSiemens. Each FTC in the series array must be monitored for voltage as it is energized. A differential amplifier 2 is used to measure the voltage across each FTC. The output of the differential amplifier 2 is the voltage across the individual FTC at any time t. This voltage is then compared via a comparator 14 to a reference signal fed back from the power supply 22. The reference signal is directly proportional to the expected charge at any time t. If the FTC voltage is different from the expected reference signal by +/−10%, for example, then the FTC is electrically shorted by relay 17. Optionally, individual FTC voltage can be allowed to vary up to 30% or more. Simultaneously, fluid 6 is turned off by valve 9, which, optionally, may be placed before, after, or on both sides of the capacitor cell. When capacitors are in discharge during regeneration, valve 9 shunts the waste to waste stream 8. During charge mode, valve 9 shunts purified flow to product stream 10. Counter 18 automatically counts the number of active cells. Alternatively, counter 18 may be preset with the starting number of individual cells, and deducts the number of cells bypassed by shorting relay 17. This counter 18 operates a controller 19, which operates a source of DC power, such as power supply 22. For example, if there are ten cells in series and it is desired to operate each cell at a maximum of one volt, the counter 18 initially reads or is set to 10, and the power supply provides 10 volts DC. If two cells 1 fail, relay 17 bypasses these failed cells, and the counter 18 reads the number eight, which information is provided to power supply 22 via controller 19, in order to provide eight volts to the series stack. Cell failure can be determined by excess current draw, voltage, or by monitoring the conductivity of the solution. Simultaneously, valve 9 shuts off fluid 6 to the particular cells. Comparator 14 operates shorting relay control circuit 15 and bypass control circuit 16, which in term actuates relay 17, and bypass or shorting relay, shut-off valve 9. A circuit breaker or fuse may also be used to turn off the electricity to an individual failed or short-circuited cell. The circuit shown here in FIG. 3B provides means to bypass electricity from and shut off fluid flow to FTCs that reach a prespecified failure level, for example, 1% or more deviation from the average. This circuit may be tied into the circuit shown in FIG. 4 at points A and B, in order to provide a means to bypass or completely shut off a cell whose failure has reached unacceptable levels and whose voltage can no longer be controlled by adjusting the flow, by FETs, transistors, etc. For example, if a cell exhibits a short circuit, it will need to be bypassed. Individual relays 17 and valves 9 should, optionally, have a manual means, for example, in case it is desired to remove a cell for service or due to other failures, such as fluid leakage.

Power sources can be any source of DC power, including batteries, buck, boost, a buck-boost switching power supply, or a linear power supply 22. A feedback signal from the power supply 22 can be used as the reference voltage for the comparator 14.

As this design will electrically monitor and control each FTC, the overall system will not benefit unless the fluid flowing through sub-optimal capacitor cells is also bypassed. Optionally, the same signal that controls the shorting relay 17 can also be used to control a shut-off or bypass valve to completely shut off the flow from the electrically bypassed FTC within the array.

In another embodiment, individual flow-through electrochemical cells 1 are connected in series. Each of N differential amplifier 2 reads a signal across each of N capacitor or cell 1, inverts it, adds this to signal from the divide by N circuit 13, to provide signal to each of N summing amplifiers 3. This signal is conditioned by conditioning circuit 4 and fed into transistor 5 to operate linearly-actuated valve 24. Optional limit switch 25 triggers valve 9 or 24 into off mode, in order to bypass a capacitor 1 that deviates from acceptable voltage range. This optional limit switch may be operated from the signal provided by differential amplifier 2 or summing amplifier 3, or optionally, conductivity controller 26. Optionally, linear valve 24 also may be controlled by conductivity controller 26. However, in the case where flow is control by conductivity controller 26, rather than by the error control circuits 13, conditioning circuit 4, and amplifiers 2 and 3, and it may be more desirable to control the voltage electronically as shown in FIG. 5, which replaces the N linear actuated valves 25 with N field electric transistor 21 shown in FIG. 3A. Power is provided by DC power supply 22, with counter 18, which counts the number of active cells providing a signal to logic controller 19 in order to control the power supply 22 voltage and/or current. Electrical connection points, where shown, are 12. Points where voltage or power is provided to circuits, where shown, are 7. Ground, where shown, is 30. Fluid feed is 6, product stream is 10, and waste stream is shown as 8. The divide by N summing amplifier 3 may either receive a signal from counter 18 or may include a counter 18. It reads voltage from either end of the capacitor stack and divides by a number proportional to the number of FTCs in the stack, in order to produce a voltage signal. This is added to the signal from the differential amplifier 2, that is in turn fed into summing amplifier 3. This, in turn, controls either a valve and valve controller circuit, such as 9 and/or 24, or the FET or similar device shown in FIGS. 3A and 3B.

FIG. 2 represents details of the error correction circuit also shown in FIG. 1, with resistor 23 drawn in.

FIG. 3A shows the optional electronic control, which may be used in place of or in addition to voltage control by the linear valve 24 valve control transistor 5. This uses the signal provided by the same summing amplifier 3 shown in FIG. 1, with the same or a separate conditioning circuit 4. This conditioning circuit 4 is shown in the FIG. 3B close up, and provides a signal to a FET, Transistor 21, or similar device, which in turn provides the desired voltage to individual cell 1.

There are N such circuits to control and monitor each cell individually, controlled with a common divide by N circuit 13 and power supply 22.

FIG. 4 shows a capacitor bypass control circuit. Voltage from individual flow-through electrochemical cells 1 is read by N differential amplifier 2, to provide a signal to N comparator 14, which in turn provide signals to each of N shorting relay control circuit 15 and each of N fluid bypass control circuits 16. Shorting relay control circuits 15 operate shorting relay 17 to bypass cell 1 electrically. Fluid bypass control circuits 19 operate valves 9 which either shut off or bypass the flow of electrolyte or fluid 6 to the affected cell 1.

FIG. 5 is a diagram of a microprocessor-controlled system. Power supply 22 provides a voltage to the cell series stack 31, as may be determined by cell counter 18 and controller logic 19. Controller 19 receives signals from each individual cell 1 in the series stack, and in turn controls the voltage across the same through the valve 24, to regulate voltage or a FET which is shown in FIG. 5.

An advantage of the flow valve regulated voltage control shown in FIG. 1 is that it avoids use of energy requiring electronics, such as the FET's shown in FIGS. 3A and 3B. Nevertheless, this FET, when combined with a bypass valve 9, is an option that is useful when used where product concentration requires that fluid flow is regulated in some way, such as by a conductivity controller 26; by mathematical formulas that predict cell performance based upon monitoring volts, amps and time; or when bad cells are bypassed by a bypass valve or the circuit shown in FIGS. 3A and 3B. The FET may also be used in combination with the valve control method of the present invention as a means to fine tune the voltages on the capacitors within 10% of each other.

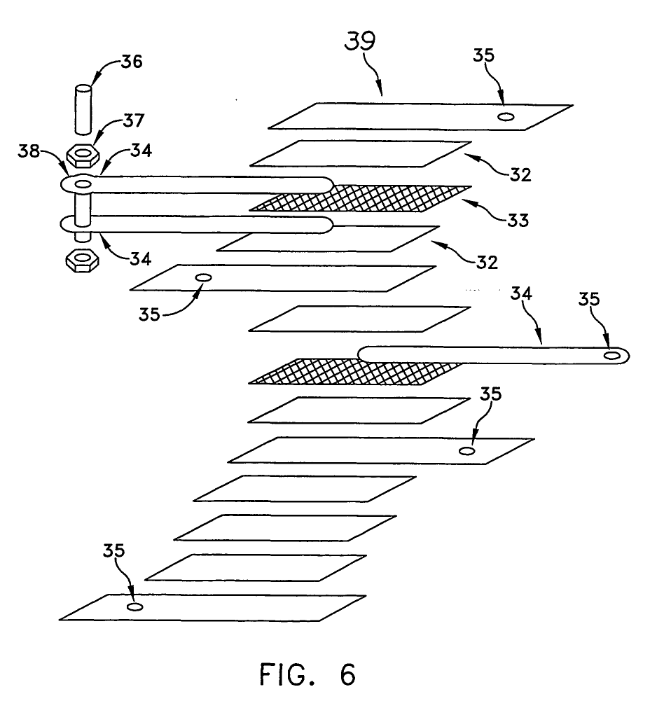

FIG. 6 depicts the arrangement of material layers in a flow-through capacitor, in order to enable separate monitoring leads 34 that are electrically isolated from the current collector leads. Current collector 39 and separate monitoring lead 34 may be comprised of graphite foil or other conductors and are separated from each other by the conductive capacitance containing material. Current collectors may be omitted in cases where material is conductive enough to form its own intrinsic current collector. Spacer 33 separates the electrode pairs formed from the material 32 and any current collector 39 and separate monitoring lead 34. The optional current collector 39 and the separate monitoring lead 34 are, optionally, provided with through hole 35 for connection to conductive lead 36. The electrical connection between monitoring lead 34 or the hole 35 in the current collector 39 is effected by nut 37 which compresses washer 38 against monitoring lead 34 or current collector 39 through use of thread means on conductive lead 36. Conductive lead 36 may be a threaded metal rod or screw or may be a threaded graphite rod.

What is claimed is:

1. A flow-through electrochemical system comprising:
a) a plurality of flow-through electrochemical cells, said system configured to place each of said cells in electrical connection and in fluid connection with each of said other cells;
b) a fluid stream;
c) means for connecting said system to a power supply;
d) means for monitoring the voltage of each of said plurality of cells; and
e) means for controlling the voltage of each of said plurality of cells.

2. The system of claim 1, wherein said controlling means comprises a valve.

3. The system of claim 2, wherein said valve is a bypass valve.

4. The system of claim 1, wherein each of said cells is a flow-through capacitor and said plurality of cells forms a series stack.

5. The system of claim 4, wherein the charge of said series stack is proportional to the sum of the capacitance of each of said cells multiplied by the voltage of each of said cells.

6. The system of claim 2, wherein the valve is actuated in a feedback loop to control the voltage of each of said cells.

7. The system of claim 1, wherein said monitoring means emit a signal.

8. The system of claim 7, wherein said signal is compared to a reference signal so as to activate said controlling means when said comparison is outside a preset range, whereby said controlling means decreases the extent of fluid connection between one or more of said cells and the remaining cells of said plurality of cells in said system.

9. The system of claim 7, wherein said monitoring means comprises a differential amplifier, and said signal is inverted.

10. The system of claim 9, said monitoring means further comprising an error amplifier which emits a signal.

11. The system of claim 2, wherein said valve is selected from the group consisting of an incremental valve, a differential valve, and a linearly-actuated valve.

12. The system of claim 1, wherein said controlling means comprises a transistor or a zener diode.

13. The system of claim 1, wherein said electrical connection is a series connection.

14. The system of claim 1, wherein said electrical connection is a parallel connection.

15. The system of claim 1, wherein said fluid connection is a series connection.

16. The system of claim 1, wherein said fluid connection is a parallel connection.

17. The system of claim 1, wherein said electrical connection is a series connection and said fluid connection is a parallel connection.

18. The system of claim 1, wherein said system is an electrical generator.

19. The system of claim 1, wherein said system is an electrical storage system.

20. The system of claim 1, wherein said system is a water purification system.

21. A method of removing a chemical species from water, said method comprising the steps of:
a) providing the flow-through electrochemical system of claim 1, wherein said fluid stream is a water stream; and
b) allowing said chemical species to be absorbed by one or more of said cells so as to remove said chemical species from said water stream.

22. A method of generating electricity, said method comprising the step of:
a) operating the system of claim 19 wherein said fluid stream is a fuel stream; and
b) providing said fuel stream.

23. A method of storing electricity, said method comprising the step of:
a) operating the system of claim 20, wherein said fluid stream is a fuel stream; and
b) providing said fuel stream.
